(19) United States
(12) Patent Application Publication
(10) Pub. No.: US 2018/0009931 A1
(43) Pub. Date: Jan. 11, 2018

(54) COMPOSITION FOR TRANSPARENT SHAPED BODIES BASED ON POLYURETHANE

(71) Applicant: Covestro Deutschland AG, Leverkusen (DE)

(72) Inventors: Robert MALEIKA, Düsseldorf (DE); Frank-Stefan STERN, Bergisch Gladbach (DE); Frank RICHTER, Leverkusen (DE); Dorota GRESZTA-FRANZ, Solingen (DE); Hans-Josef LAAS, Odenthal (DE)

(21) Appl. No.: 15/543,075

(22) PCT Filed: Jan. 13, 2016
(86) PCT No.: PCT/EP2016/050551

§ 371 Date: Jul. 12, 2017

(30) Foreign Application Priority Data
Jan. 14, 2015 (EP) 15151192.0

(51) Int. Cl. C08G 18/24; C08K 5/521; C08G 18/75; C08G 18/72; C08G 18/78; C08G 18/48; G02B 1/04

(52) U.S. Cl. CPC C08G 18/24; C08G 18/7831; C08K 5/521; C08G 18/48; C08G 18/755; C08G 18/725; G02B 1/041

(57) ABSTRACT

A composition comprising an isocyanate component A) comprising at least one cycloaliphatic or araliphatic diisocyanate, a polyol component B) comprising at least one polyol having an OH number of 80 to 1000 mg KOH/g, an additive component C) comprising at least one internal demoulding agent, and a catalyst component D) comprising at least one inorganic metal complex as thermally latent catalyst, characterized in that the thermally latent catalyst has a quotient of reaction rates between catalysed reaction and uncatalysed reaction at 30° C. of =5.0 and at 60° C. of =1.1. The present invention further provides a process for producing an elastomer and for the use of the composition for production of transparent shaped bodies.

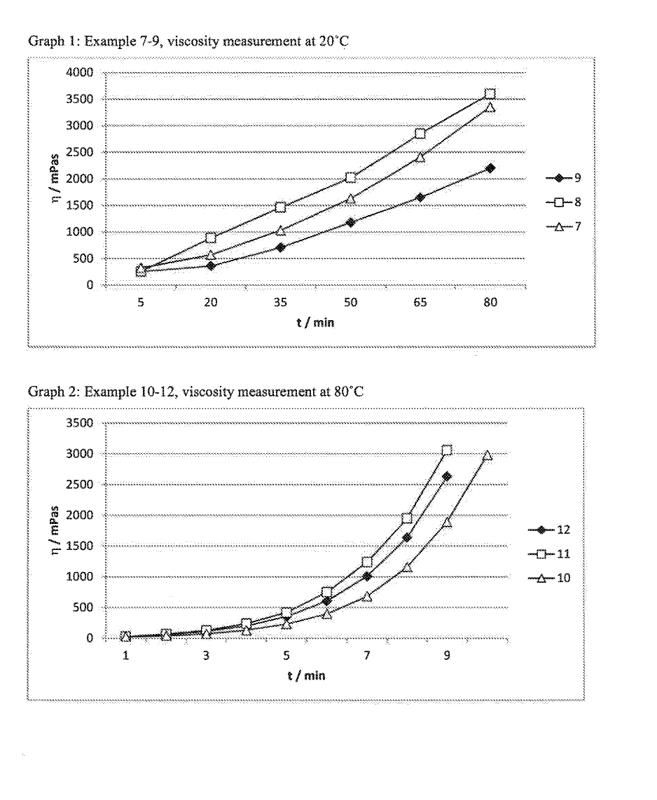

The invention relates to a composition comprising an isocyanate component, a polyol component, an additive component and a catalyst component. The invention further relates to a process for producing an elastomer, to the elastomer and to the use of the composition for producing transparent molded articles. The invention further relates to the transparent molded articles.

Transparent plastics are nowadays replacing glass in many sectors in the production of optical components. Even in optical lenses such as eyeglasses lenses polymeric materials of construction show their advantages in terms of low weight, higher breaking strength and easier processability which is why they are substituting traditionally used mineral glass more and more.

Industrial production of organic eyeglasses lenses from thermosetting plastics may for example be effected by a special casting proses where liquid reaction mixtures are admixed with additives, for example UV absorbers, filled into glass casting molds at temperatures as far as possible below their curing temperatures and subsequently cured in an exactly temperature control process over many hours.

Polyurethane-based elastomers are playing an increasingly important role as a material for plastics lenses. There are particular requirements in respect of the optical quality of the cured plastics. A person skilled in the art is already aware of the use of catalysts for accelerated curing.

However, one disadvantage is that the NCO—OH reaction which already takes place at room temperature is further accelerated by the presence of the catalyst and the processing window (potlife) available for processing the ready-formulated mixture of such a system is therefore short or shorter.

Thermolatent catalysts have been developed in order to circumvent this problem as far as possible. It is a feature of these compounds that they show only little if any activity at low temperatures and develop their catalytic activity only at elevated temperatures. On account of these properties ready-formulated mixtures for producing elastomers comprising thermolatent catalysts can at low temperatures exhibit a potlife only minimally reduced compared to the corresponding uncatalyzed systems. Such catalysts are disclosed for use in polyurethane coatings in WO2011/051247 A1 for example.

WO 2008/092597 A2 discloses a composition for producing polyurethane-based optical lenses using metal salts such as for example dibutyltin(IV) dilaurate (DBTL), zinc naphthenate, bismuth(III) nitrate or phenylmercury neodecanoate as catalysts. Of these catalysts phenylmercury neodecanoate is already known as a thermolatent catalyst while zinc naphthenate is not a thermolatent catalyst.

However, phenylmercury neodecanoate also results in a reduced potlife of the composition compared to an uncatalyzed system. Conventional polyurethane-based elastomers moreover exhibit great adhesion toward the casting mold and said elastomers therefore suffer from very poor demolding.

The present invention accordingly has for its object the provision of a composition which exhibits an extended potlife compared to a non-catalyzed system and from which transparent molded articles, preferably optical lenses, featuring very good demolding properties may be produced.

This object is achieved in accordance with the invention by a composition comprising an
isocyanate component A) comprising at least one cycloaliphatic or araliphatic diisocyanate, a
polyol component B) comprising at least one polyol having an OH number of 80 to 1000 mg KOH/g, an
additive component C) comprising at least one internal demolding agent, wherein the demolding agent is at least one mono- and/or dialkyl phosphate having 8 to 12 carbon atoms in the alkyl radical, and a
catalyst component D) comprising at least one inorganic metal complex compound as a thermolatent catalyst,
characterized in that the thermolatent catalyst exhibits a quotient of the reaction rates between catalyzed reaction and uncatalyzed reaction of≦5.0 at 30° C. and of≧1.1 at 60° C.

It has now been found that, surprisingly, the composition according to the invention as an extended pop life compared to catalyst-free systems and is also more readily demolded.

In the context of the present invention a thermolatent catalyst is to be understood as meaning a catalyst where the quotient of reaction rates between catalyzed reaction and uncatalyzed reaction is ≦5.0 at 30° C. and ≧1.1 at 60° C. It is further preferred when the quotient of the reaction rates between catalyzed reaction and uncatalyzed reaction is ≦4.0 at 30° C. and ≧1.15 at 60° C., particularly preferably ≦3.0 at 30° C. and ≧1.2 at 60° C. This is measured with reference to the model reaction between an HDI-based isocyanurate and 2-ethylhexanol, wherein the isocyanate groups and the hydroxyl groups are employed in an equimolar ratio. The rate law

$${v}_{R} = - \frac{Δ {c}_{NCO}}{Δ t} , \qquad ( 1 )$$

applies, wherein ν_{R} represents reaction rate. The concentration of the isocyanate groups c_{NCO} is determined at the time of mixing and after 2 hours at 30° C. by titration in accordance with DIN 53 185 (NCO content) and also after 2 further hours at 60° C. The concentration of the catalyst is between 160 and 200 μmol of central atom per kilogram of polyisocyanate hardener, wherein the term central atom is to be understood as meaning the respective metal atoms of the inorganic metal complex compound.

$$Quotient at {30}^{°} C \text{:} \frac{{v}_{R , {30}^{°} C , catalyzed}}{{v}_{R , {30}^{°} C , uncatalyzed}} = \frac{{c}_{NCO Start} - {c}_{NCO 2 h , {30}^{°} C , catalyzed}}{{c}_{NCO Start} - {c}_{NCO 2 h , 30 ° C , uncatalyzed}}$$

$$Quotient at {60}^{°} C \text{:} \frac{{v}_{R , {60}^{°} C , catalyzed}}{{v}_{R , {60}^{°} C , uncatalyzed}} = \frac{\begin{matrix}{c}_{NCO Start} - \\ {c}_{NCO 2 h , {30}^{°} C , 2 h , {60}^{°} C , catalyzed}\end{matrix}}{\begin{matrix}{c}_{NCO Start} - \\ {c}_{NCO 2 h , {30}^{°} C , 2 h , {60}^{°} C , uncatalyzed}\end{matrix}}$$

In the context of the present invention an internal demolding agent is a demolding agent which is a constituent of the composition according to the invention. By contrast an external demolding agent is in the present case to be understood as meaning a demolding agent which is applied to the surface of the casting mold and is not a constituent of the composition according to the invention.

In the context of the present invention, the term “transparent” is to be understood as meaning that the transparent article has a transmittance of ≧90% for a thickness of 2 mm and standard light type D65 (defined in DIN 6173). However, this transmittance value can deviate from the aforementioned value of ≧90% in case of optional use of UV stabilizers and dyes.

According to a first preferred embodiment of the invention the inorganic metal complex compound comprises bismuth, titanium, zinc, zirconium or tin, preferably bismuth or tin and particularly preferably tin as the central atom. These feature inter alia improved activity at relatively high temperatures.

In a further preferred embodiment the inorganic metal complex compound comprises at least one ligand which comprises at least one ether, thioether or amino group and/or is a chelate ligand, preferably comprises at least one amino group and/or is a chelate ligand and particularly preferably comprises at least one amino group and is a chelate ligand. This gives rise to the advantage that these ligands allow the thermolatent properties of the catalysts to be further increased.

In a further preferred embodiment the inorganic metal complex compound is selected from the group of formulae I, II or III:

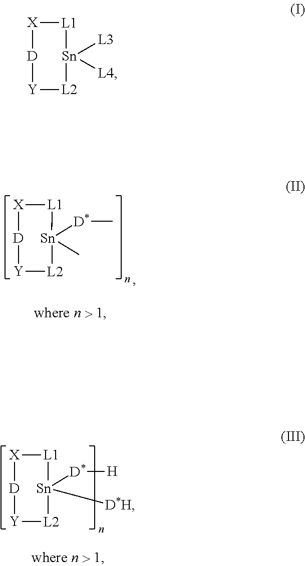

wherein:

D represents —O—, —S— or —N(R1)—,
wherein. R1 represents a saturated or unsaturated, linear or branched, aliphatic or cycloaliphatic radical or an optionally substituted aromatic or aliphatic radical having up to 20 carbon atoms which may optionally comprise heteroatoms from the group of oxygen, sulfur, nitrogen or represents hydrogen or the radical

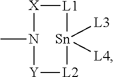

or R1 and L3 together represent —Z-L5-;

D* represents —O— or —S—;

X, and Z represent identical or different radicals selected from alkylene radicals having the formulae —C(R2)(R3)—, —C(R2)(R3)—C(R4)(R5)— or —C(R2)(R3)—C(R4)(R5)—C(R6)(R7)— or ortho-arylene radicals having the formulae

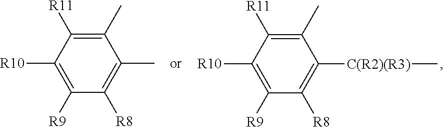

wherein R2 to R1 I independently of one another represent saturated or unsaturated, linear or branched, aliphatic or cycloaliphatic or optionally substituted aromatic or aliphatic radicals having up to 20 carbon atoms which may optionally comprise heteroatoms from the group of oxygen, sulfur, nitrogen or represent hydrogen;

L1, L2 and L5 independently of one another represent —O—, —S—, —SC(═S)—, —OS(═O)₂O—, —OS(═O)₂— or —N(R12)—,
wherein R12 represents a saturated or unsaturated, linear or branched, aliphatic or cycloaliphatic radical or an optionally substituted aromatic or aliphatic radical having up to 20 carbon atoms which may optionally comprise heteroatoms from the group of oxygen, sulfur, nitrogen or represents hydrogen;

L3 and L4 independently of one another represent —OH, —SH, —OR13, Hal, —OC(═O)R14, —SR15, —OC(═S)R16, —OS(═O)₂OR17, —OS(═O)₂R18 or —NR19R20 or L3 and L4 together represent -L1-X-D-Y-L2-,
wherein R13 to R20 independently of one another represent saturated or unsaturated, linear or branched, aliphatic or cycloaliphatic or optionally substituted aromatic or aliphatic radicals having up to 20 carbon atoms which may optionally comprise heteroatoms from the group of oxygen, sulfur, nitrogen or represent hydrogen;

D preferably represents —N(R1)-, wherein. R1 is hydrogen or an aralkyl alkaryl- or aryl radical having up to 20 carbon atoms or is the radical

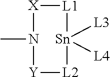

and I) particularly preferably represents —N(R1)—, wherein R1 is hydrogen or a methyl, ethyl, propyl, butyl, hexyl, octyl, Ph, or CH₃Ph radical or is the radical

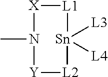

and wherein propyl, butyl, hexyl and octyl represent all isomeric propyl, butyl, hexyl and octyl radicals.

The units L1-X, L2-Y and L5-Z preferably represent —CH₂CH₂O—, —CH₂CH(Me)O—, —CH(Me)CH₂O—, —CH₂C(Me)₂O—, —C(Me)₂ CH₂O— or —CH₂C(═O)O—.

The unit L1-X-D-Y-L2 particularly preferably represents: HN[CH₂CH₂O—]₂, HN[CH₂CH(Me)O—]₂, HN[CH₂CH(Me)O—][CH(Me)CH₂O—], HN[CH₂C(Me)₂O—]₂, HN[CH₂C(Me)₂O—][C(Me)₂CH₂O—], HN[CH₂C(═O)O—]₂, MeN[CH₂CH₂O—]₂, MeN[CH₂CH(Me)O—]₂, MeN[CH₂CH(Me)O—][CH(Me)CH₂O—], MeN[CH₂C(Me)₂O—]₂, MeN[CH₂C(Me)₂O—][C(Me)₂CH₂O—], MeN[CH₂C(═O)O—]₂, EtN[CH₂CH₂O—]₂, EtN[CH₂CH(Me)O—]₂, EtN[CH₂CH(Me)O—][CH(Me)CH₂O—], EtN[CH₂C(Me)₂O—]₂, EtN[CH₂C(Me)₂O—][C(Me)₂CH₂O—], EtN[CH₂C(═O)O—]₂, PrN[CH₂CH₂O—]₂, PrN[CH₂CH(Me)O—]₂, PrN[CH₂CH(Me)O—][CH(Me)CH₂O—], PrN[CH₂C(Me)₂O—]₂, PrN[CH₂C(Me)₂O—][C(Me)₂CH₂O—], PrN[CH₂C(═O)O—]₂, BuN[CH₂CH₂O—]₂, BuN[CH₂CH(Me)OH₂, BuN[CH₂CH(Me)O—][CH(Me)CH₂O-], BuN[CH₂C(Me)₂O—]₂, BuN[CH₂C(Me)₂O—][C(Me)₂CH₂O—], BuN[CH₂C(═O)O—]₂, HexN[CH₂CH₂O—]₂, HexN[CH₂CH(Me)O—]₂, HexN[CH₂CH(Me)O—][CH(Me)CH₂O—], HexN[CH₂C(Me)₂O—]₂, HexN[CH₂C(Me)₂O—][C(Me)₂CH₂O—], HexN[CH₂C(═O)O—]₂, OctN[CH₂CH₂O—]₂, OctN[CH₂CH(Me)O—]₂, OctN[CH₂CH(Me)O—][CH(Me)CH₂O—], OctN[CH₂C(Me)₂O—]₂, OctN[CH₂C(Me)₂O—][C(Me)₂CH₂O—], OctN[CH₂C(═O)O—]₂, wherein Pr, Bu, Hex and Oct may represent any isomeric propyl, butyl and octyl radicals, PhN[CH₂CH₂O—]₂, PhN[CH₂CH(Me)O—]₂, PhN[CH₂CH(Me)O—][CH(Me)CH₂O—], PhN[CH₂C(Me)₂O—]₂, PhN[CH₂C(Me)₂O—][C(Me)₂CH₂O—], PhN[CH₂C(═O)O—]₂,

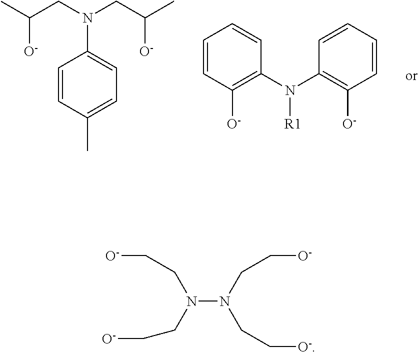

As is known to a person skilled in the art the tin compounds have a propensity for oligomerisation and polynuclear metal compounds or mixtures of mono- and polynuclear metal compounds are therefore often present. In the polynuclear tin compounds the tin atoms are preferably connected to one another via oxygen atoms (‘oxygen bridges’, vide intra). Typical oligomeric complexes (polynuclear tin compounds) are formed for example by condensation of the tin atoms via oxygen or sulfur, for example

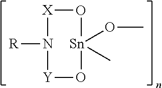

where n>1 (cf. formula II). Cyclic oligomers are frequently encountered in the case of low degrees of oligomerization, linear oligomers with OH or SH end groups in the case of high degrees of oligomerization (cf. formula III).

In the cases in which the tin compounds comprise ligands with free OH radicals and or NH radicals the catalyst can be incorporated into the product in the polyisocyanate polyaddition reaction.

According to a further very particularly preferred embodiment the inorganic metal complex compound is selected from the group consisting of 4,12-dibutyl-2,6,10,14-tetramethyl-1,7,9,15-tetraoxa-4,12-diaza-8-stannaspirol[7.7]pentadecane, 4,12-dibutyl-1,7,9,15-tetraoxa-4,12-diaza-8-stannaspirol[7.7]pentadecane, 4,12-dimethyl-1,7,9,15-tetraoxa-4,12-diaza-8-stannaspirol[7.7]pentadecane, 2,4,6,10,12,14-hexamethyl-1,7,9,15-tetraoxa-4,12-diaza-8-stannaspirol[7.7]pentadecane and 2,2-dichloro-6-methyl-1,3,6,2-dioxazastannocane.

The inorganic metal complex compound may preferably be present in a concentration of >0 to ≦2000 mg, preferably of ≧0.1 to ≦1000 mg, particularly preferably of ≧5 to ≦300 mg and very particularly preferably of ≧10 to ≦100 mg in mg of central atom per kg of total weight of the composition according to the invention.

In a further preferred embodiment the internal demolding agent preferably comprises a compound having a pK_{A} of ≦4.60. The pK_{A} may be determined for example by acid-base titration using a pH electrode.

The mono- and dialkyl phosphates have 8 to 12 carbon atoms in the alkyl radical.

Suitable internal demolding agents are for example octyl phosphate, dioctyl phosphate, decyl phosphate, isodecyl phosphate, diisodecyl phosphate, isodecyloxyethyl phosphate, di(decyloxyethyl) phosphate, dodecyl phosphate, didoceyl phosphate, tridecanole phosphate, bis(tridecanol) phosphate, stearyl phospate, distearyl phosphate and any desired mixtures of such compounds.

In a further preferred embodiment the internal demolding agent is selected from the group consisting of C₈-monophosphoric esters, C₈-diphosphoric esters, C₁₀-monophosphoric esters, C₁₀-diphosphoric esters and/or mixtures thereof, wherein the mixtures are particularly preferable. Very particular preference is given to a mixture comprising 40 wt % of monophosphoric ester and 60 wt % of diphosphoric ester.

The internal demolding agents may preferably be present in the composition according to the invention in amounts of 0.01 to 6.00 wt %, particularly preferably 0.02 to 4.00 wt % and particularly preferably 0.10 to 3.00 wt % based on the total weight of the composition.

The isocyanate component A) comprises at least one cycloaliphatic or araliphatic diisocyanate.

A development of the invention provides that the isocyanate component A) comprises a mixture of a) at least one cycloaliphatic or aliphatic diisocyanate and b) at least one acyclic, aliphatic di- or triisocyanate or one oligomer of an aliphatic diisocyanate, preferably a mixture of a) at least one cycloaliphatic diisocyanate or araliphatic diisocyanate and b) at least one oligomer of an aliphatic isocyanate.

It is particularly preferable when the mixture in the isocyanate component A) is present in a weight ratio of a) to b) between 55:45 and 94:6, preferably between 60:40 and 90:10 and particularly preferably between 70:30 and 85:15.

It is likewise further preferred when the oligomer of an aliphatic diisocyanate comprises at least one allophanate, one biuret, one uretdione, one isocyanurate and/or one urethane group, preferably at least one allophanate, one biuret and/or one urethane group and particularly preferably at least one allophanate and/or one biuret group.

It is very particularly preferable when the aliphatic diisocyanate is a linear aliphatic diisocyanate, preferably 1,6-hexamethylene diisocyanate.

According to a further preferred embodiment the isocyanate component A) comprises at least 3,5,5-trimethyl-1-isocyanato-3-isocyanatomethylcyclohexane, 4,4′-methylenebis(cyclohexyl isocyanate), 1,3-bis(isocyanatomethyl)benzene, 1,4-bis(isocyanatornethyl)benzene, 2,5-bis(isocyanatomethyl)bicyclo[2,2.1]heptane, 2,6-bis(isocyanatomethyl)bicyclo[2.2.1]heptane, 1,3-diisocyanato-2-methylcyclohexane and/or 1,3-diisocyanato-6-methylcyclohexane, preferably at least 3,5,5-trimethyl-1-isocyanato-3-isocyanatomethylcyclohexane and/or 4,4′-methylbiscyclohexyl isocyanate and particularly preferably 3,5,5-trimethyl-1-isocyanato-3-isocyanatomethylcyclohexane.

Polyol component B) comprises at least one polyol having an OH number of 80 to 1000 mg KOH/g. The OH number is determined according to DIN 53240 T.2.

Suitable polyols preferably have a hydroxyl functionality of 1.8 to 6.5, preferably of 2.5 to 4.5, particularly preferably of 2.8 to 3.2.

According to a further preferred embodiment the polyol component B) comprises at least one polyether polyol or one polyester polyol, preferably at least one polyether polyol and particularly preferably a trimethylolpropane-initiated polyether polyol or mixtures of a trimethylolpropane-initiated polyether polyol with at least one further polyether polyol.

The polyether polyol preferably has an. OH number of 80 to 1000 mg KOH/g, particularly preferably of 110 to 800 mg KOH/g, very particularly preferably of 150 to 600 mg KOH/g. The OH number is determined according to DIN 53240 T.2.

The polyether polyol preferably has a viscosity at 23° C. of 200 to 6 000 mPa·s, particularly preferably of 800 to 5 800 mPa·s, very particularly preferably of 1 500 to 4 500 mPa·s.

In a further preferred embodiment the isocyanate groups of the isocyanate component A) and the hydroxyl groups of the polyol component B) are in a ratio of 1.50:1,00 to 1.00:1.50, preferably of 1.20:1.00 to 1.00:1.20 and particularly preferably of 1.15:1.00 to 1.05:1.00.

The transparent molded articles obtainable from the composition according to the invention generally feature very good light resistance even as such, i.e. without addition of appropriate stabilizers.

However, independently of the particular embodiment the composition according to the invention may comprise further auxiliary and additive substances. These are preferably selected from the group consisting of UV stabilizers, dyes and antioxidants and may be present either singly or in any desired mixtures. If used, the optionally present auxiliary and additive substances may be present in the composition either in one of components A) to D) or else separately. It is particularly preferable when the assistant and additive substances for optional use are present in additive component C).

Suitable UV stabilizers may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or 2,2′-dihydroxy-4-dodecyloxybenzophenone; benzotriazole derivatives, for example 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3 -tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxylphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides, for example 2-ethyl-2′-ethoxy- or 4-methyl-4′-methoxyoxalanilide; salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred UV stabilizers may be employed either singly or in any desired combinations with one another.

Particularly preferred UV stabilizers for the composition according to the invention are those which completely absorb radiation having a wavelength of <400 nm so that when the composition according to the invention is used as eyeglass lenses complete protection of the eye from UV radiation is ensured. These include for example the recited benzotriazole derivatives. Very particularly preferred UV stabilizers are 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol and/or 2-(5-chloro-2H-benzotriazol-2-yl)-4,6-bis(1,1-dimethylethyl)phenol.

The UV stabilizers recited by way of example may preferably be present in amounts of 0.0001 to 3.5 wt %, particularly preferably of 0.001 to 3.0 wt % and very particularly preferably of 0.01 to 2.0 wt % calculated as the total amount of employed UV stabilizers based on the total weight of the composition according to the invention.

Suitable dyes for the composition according to the invention may preferably be selected from the group consisting of commercially available anthraquinone dyes, for example Exalite Blue 78-13 from Exciton, Inc., Dayton, Ohio, USA or Macrolex Violet B, Macrolex Blue RR and Macrolex Violet 3R from Lanxess AG, Leverkusen, DE, and any desired mixtures thereof.

The dyes recited by way of example may preferably be present in amounts of 0.0001 to 3.5 wt %, particularly preferably of 0.001 to 3.0 wt % and very particularly preferably of 0.01 to 2.0 wt % calculated as the total amount of employed dyes based on the total weight of the composition according to the invention.

Suitable antioxidants are preferably sterically hindered phenols, which may preferably be selected from the group consisting of 2,6-di-tert-butyl-4-methylphenol (ionol), pentaerythrityl tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. The aforementioned antioxidants may be present either singly or else in any desired combinations with one another if required.

The antioxidants recited by way of example may preferably be used in amounts of 0.001 to 3.5 wt %, particularly preferably of 0.01 to 3.0 wt % and very particularly preferably of 0.02 to 2.0 wt % calculated as the total amount of employed antioxidants based on the total amount of the composition according to the invention.

The composition according to the invention may generally comprise the individual components in any desired quantity ratios. In a preferred embodiment the composition according to the invention consists of components A) to D).

According to the very particularly preferred embodiment the composition according to the invention comprises 45-65 parts by wt of the isocyanate component A) comprising at least one cycloaliphatic or araliphatic diisocyanate, 30-50 parts by wt of the polyol component B) comprising at least one polyol having an OH number of 80 to 1000 mg KOH/g, 0.1 to 10 parts by wt of the additive component C) comprising at least one internal demolding agent and 0.0001 to 0.2 parts by wt of the catalyst component D) comprising at least one inorganic metal complex compound as a thermolatent catalyst, wherein the thermolatent catalyst exhibits a quotient of the reaction rates between catalyzed and uncatalyzed reaction of 5.0 at 30° C. and of 1.1 at 60° C. and the respective parts by weight are optionally normalized such that the parts by weight sum to 100.

The different methods of production for the tin(IV) compounds for use in accordance with the invention or their tin(II) precursors are described inter alia in: J. Organomet. Chem. 2009 694 3184-3189, Chem. Heterocycl. Comp. 2007 43 813-834, Indian J. Chem. 1967 5 643-645 and in the literature cited therein.

The abovementioned di- or triisocyanates of the isocyanate component A) may be produced for example from the corresponding amine compounds by known processes, for example by phosgenation or by a phosgene-free route, for example by urethane cleavage. The recited diisocyanates may be used to produce for example polyisocyanates having a uretdione, isocyanurate, allophanate, biuret, iminooxadiazinedione and/or oxadiazinetrione structure, such as are described inter alia in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

Suitable polyester polyols of the polyol component B) are obtainable for example by methods such as are described in detail for example in “Ullmanns Encyclopädie der Technischen Chemie”, Verlag Chemie Weinheim, 4th edition (1980), volume 19, pages 61 et seq. or by H. Wagner and H. F. Sarx in “Lackkunstharze”, Carl Hanser Verlag, Munich (1971), pages 86 to 152.

Suitable polyether polyols of polyol component B) are obtainable for example by the processes described in DE-A 2 622 951, column 6, line 65-column 7, line 47, or in EP-A 0 978 523, page 4, line 45 to page 5, line 14, for example by alkoxylation of suitable starter molecules with alkylene oxides.

Suitable starter molecules for producing the polyether polyols employed according to the invention include any desired compounds of the molecular weight range 60 to 200. Preference is given to starting compounds free from aromatic structures. These starting compound moreover preferably bear 3 to 6, particularly preferably up to 4, reactive hydrogen atoms. These are preferably simple aliphatic alcohols having 3 to 6 carbon atoms which may for example be selected from the group consisting of 1,2,3-propanetriol, 1,1,1-trimethylolethane, 1,2,6-hexanetriol, 1,1,1-trimethylolpropane, 2,2-bis(hydroxymethyl)-1,3-propanediol, 1,2,4- and 1,3,5-trihydroxycyclohexane and sorbitol, aliphatic diamines which may for example be selected from the group consisting of ethylenediamine, 1,3-propylenediamine and the isomeric butylenediamines, pentylenediamines and hexylenediamines, which may optionally be monosubstituted on a nitrogen atom by alkyl radicals having 1 to 4 carbon atoms, or else aliphatic polyamines which may for example be selected from the group consisting of diethylenetriamine and triethylenetriamine. A further preferred class of suitable starting molecules are moreover, alkanolamines, for example ethanolamine, dialkanolamines, for example diethanolamine, and trialkanolamines, for example triethanolamine. These starter molecules may be employed either alone or else in the form of any desired mixtures with one another.

Alkylene oxides suitable for the alkoxylation reaction are in particular ethylene oxide and propylene oxide. They may be reacted with the recited starter molecules either alone or else sequentially in any desired order or in the form of any desired mixtures with one another. Particularly preferred polyether polyols are addition products of ethylene oxide and/or propylene oxide onto glycerol, 1,2,3-propanetriol, 1,1,1-trimethylolpropane, ethylenediamine and/or pentaerythritol.

Very particularly preferred polyether polyols are those whose production employs exclusively propylene oxide as the alkylene oxide.

In addition, suitable polyether polyols also include polytetramethylene ether glycols such as are obtainable in accordance with Angew. Chem. 1960 72 927 by polymerization of tetrahydrofuran for example.

In addition to the polyether polyols production of the composition according to the invention may optionally also employ minor amounts of simple, low molecular weight, at least trifunctional, alcohols. These preferably have molecular weights from 92 to 182. These are used, if at all, in amounts of up to 10 wt %, preferably up to 5 wt %, based on the total amount of the polyether polyol. In a preferred embodiment the polyether polyol is free from low molecular weight, at least trifunctional, alcohols.

The composition according to the invention may be produced for example by a process where the aforementioned components A) to D) are mixed with one another. Components A) to D) are preferably employed in the abovementioned quantity ratios.

In a further preferred embodiment of the process according to the invention one or more of components A) to D) are mixed with one another beforehand. It is thus possible for example for the additive component C) and/or the catalyst component D) to be mixed with the isocyanate component A) and for this mixture to be added to the polyol component B). It is alternatively likewise possible for the additive component C) and/or the catalyst component D) to be mixed with the polyol component B) and for this mixture to be added to the isocyanate component A).

In a further preferred embodiment the additive component C) is mixed with the isocyanate component A) and the mixture obtained is stored. The produced mixture is preferably stored for 1 to 10 hours or longer before components B) and D) are added. The mixing and/or the storage may be effected at a temperature of 10° C. to 100° C.

The composition according to the invention may be cured, optionally with heating, to afford an elastomer. The invention therefore further provides such a process for producing and elastomer. The invention further provides the elastomers obtainable by the process according to the invention.

To produce the elastomer according to the invention the composition according to the invention may in accordance with a further preferred embodiment be passed into a casting mold at temperatures between −10° C. and 80° C., preferably between 10° C. and 40° C., particularly preferably between 20° C. and 30° C. The filled casting mold may be stored for 0 to 10 hours at temperatures between −10° C. and 80° C., preferably between 10° C. and 40° C., particularly preferably between 20° C. at 30° C., and subsequently heated to 150° C., preferably to 130° C., over 0.5-48 hours, preferably 1-24 hours. The heating may be effected in stages.

After the filling of the casting mold the mixture may be heated to the maximum temperature to obtain good through-curing. It is also possible to use more than two temperature hold times or gradual continuous (for example linear) heating. After curing the mixture may be slowly cooled, typically at temperatures between 20° C. and 70° C. A heat treatment step at a temperature below the highest curing temperature may also be chosen. Once the mold has cooled the components may be removed from the casting mold. A subsequent heat treatment at temperatures >80° C. may to reduce any stresses in the transplant molded articles.

The casting mold may have been produced from glass for example. In addition, an external demolding agent may optionally be applied to the surface of the casting mold coming into contact with the composition according to the invention before the filling of the composition. according to the invention.

The casting mold may be filled manually or else by automated methods, for example reactive injection molding (RIM), reactive transfer molding (RTF). For the latter, it is then also possible to manufacture the casting mold from other materials, preferably from metals (for example stainless steel but also iron, nickel, copper, aluminum, chromium, silver, gold or alloys thereof). The sleeve may in particular likewise be manufactured from metal.

Mixing can be accomplished using stirring tools, static mixers, fast-moving vessels and the like. It is also advantageous to degas the casting system. For this purpose, reduced pressure may be applied and/or the surface area can be increased by means of a falling film, which avoids bubble formation.

The composition according to the invention is suitable for a multiplicity of applications, for example for producing transparent molded articles. The invention therefore further provides for the use of the composition according to the invention for producing transparent molded articles.

In a further preferred embodiment the transparent molded article is an optical lens or a part of an optical lens, wherein the optical lens may be a converging lens, a diverging lens, a glazing, a headlight or an eyeglasses lens, preferably an eyeglasses lens.

After curing in the casting mold made of a suitable material, for example of glass, the transparent molded article may be obtained by separation from the mold. The advantageous properties of the elastomer according to the invention are exhibited here since said elastomer features very good demolding characteristics compared to the conventional polyurethane-based elastomers.

The invention therefore further provides transparent molded articles comprising an elastomer according to the invention. In addition to the elastomer according to the invention the transparent molded article may also comprise further components and said article may therefore be adapted to individual requirements. Advantages of the transparent molded articles produced from the elastomer according to the invention, preferably optical lenses and particularly preferably eyeglasses lenses are for example a high impact strength, good coatability, polishability or very good optical properties, for example a high refractive index.

The invention is hereinbelow more particularly elucidated with reference to examples.

### EXAMPLES

All reported percentages are based on weight unless otherwise stated.

All viscosity measurements were taken with a Physica MCR 51 rheometer from Anton Paar Germany GmbH (DE) according to DIN EN ISO 3219 at the temperatures reported in each case.

Refractive indices and Abbe numbers were measured using an AR4D Abbe refractometer from A.KRÜSS Optronic GmbH at 23° C.

Transmission measurements according to ASTM D 1003 were performed with a Byk Haze-Gard Plus using standard light type D65 (defined in DIN 6173).

NCO contents were determined by titration according to DIN 53 185.

Raw Materials Employed in Examples:

Desmodur® N 3300: an isocyanurate-containing polyisocya.nate of 1,6-hexamethylene diisocyanate, Bayer MaterialScience AG, Leverkusen, DE

2-ethylhexanol: product of Aldrich, Taufkirchen, DE

Desmodur® I: 3,5,5-trimethyl-1-isocyanate-3-isocyanatomethylcyclohexane (isophorone diisocyanate), Bayer MaterialScience AG, Leverkusen, DE

Desmodur® N 3200: a biuret-containing polyisocyanate of 1,6-hexamethylene diisocyanate, Bayer MaterialScience AG, Leverkusen, DE

Desmophe® 4011 T: trifunctional polyether polyol, Bayer MaterialScience AG, Leverkusen, DE

Zelec® UN: Internal acidic phosphate ester demolding agent, Stepan Company, Northfield, Ill., USA

Determination of Catalyst Activity (Thermolatency)

All reactions for determining catalyst activity were performed under a dry nitrogen atmosphere. The catalysts from table 1 were obtained by standard literature procedures (cf. Chem. Heterocycl. Comp. 2007 43 813-834 and literature cited therein), DBTL was obtained from Kever Technologie, Ratingen, DE, zinc naphthenate from Alfa Aesar GmbH & Co KG, DE.

For better comparability of the activity of the catalysts for use in accordance with the invention and the catalysts from the comparative examples the catalyst amount was reported as μmol of Sn or Zn per kg of polyisocyanate hardener.

Desmodur® N 3300 was employed as the polyisocyanate hardener and precisely one equivalent of 2-ethylhexanol (based on the free isocyanate groups of the polyisocyanate hardener) was employed as the model compound for the isocyanate-reactive component. Addition of 10% (based on Desmodur® N 3300) of n-butyl acetate ensured that over the entire course of the reaction samples of sufficiently low viscosity could be taken which allow precise capture of the NCO content by titration according to DIN 53 185. The NCO content calculated at the beginning of the reaction without any NCO-OH reaction whatsoever is 12.2%.

For the experiments the mixtures were stored at a constant 30° C. and subsequently heated to 60° C. for 2 h in each case. Table 2 shows the reduction in the NCO content. Quotients Q₃₀ und Q₆₀ were determined as elucidated in detail in the description.

TABLE 1
Overview of employed catalysts for determination of catalyst activity
(DBTL and also cat. 1 and zinc naphthenate comparative, cat. 2 to 5 inventive)

| | | | Molar | |
|---|---|---|---|---|
| | | Empirical | Weight | Sn |
| Catalyst | Structural formula | formula | [g/mol] | content |
| DBTL (comparative) | 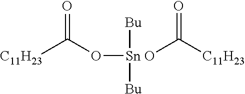 | C32H64O4Sn | 631.55 | 18.79% |
| Cat. 1 (comparative) | 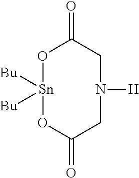 | C12H23NO4Sn | 364.01 | 32.61% |
| Cat. 2 (inventive) | 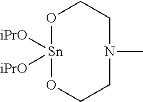 [SMILES: CC(C)[O][Sn]1([O]C(C)C)[O]CCN(C)CC[O]1] | C11H25NO4Sn | 354.02 | 33.53% |
| Cat. 3 (inventive) | 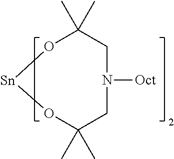 | C32H66N2O4Sn | 661.58 | 17.94% |
| Cat. 4 (inventive) | 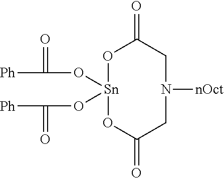 | C26H31NO8Sn | 604.23 | 19.64% |
| Cat. 5 (inventive) | 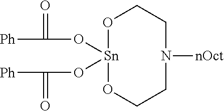 | C26H35NO6Sn | 576.26 | 20.60% |
| Zinc | | | | 0% |
| naphthenate | | | | |
| (comparative) | | | | |

TABLE 2
Overview of determination of catalyst activity (Example a-c and h: comparative
examples, examples d to g: inventive)

| | | | NCO content of the mixture after [hh:mm] | | | | | | | | | |
|---|---|---|---|---|---|---|---|---|---|---|---|---|
| | | Cat. | 30° C. | | | | 60° C. | | | | | |
| No. | Cat | Conc.¹⁾ | 00:30 | 1:00 | 1:30 | 2:00 | 2:30 | 3:00 | 3:30 | 4:00 | Q₃₀ | Q₆₀ |
| a | none | 0 | 11.9 | 11.7 | 11.6 | 11.4 | 10.5 | 9.0 | 7.6 | 6.6 | | |
| b | DBTL | 177 | 7.9 | 6.4 | 5.9 | 5.3 | 2.7 | 1.8 | 1.3 | 1.1 | 8.6 | 2.0 |
| c | cat. 1 | 185 | 8.9 | 7.1 | 5.7 | 4.7 | 0.9 | 0.3 | 0.2 | 0.1 | 9.4 | 2.2 |
| d | cat. 2 | 194 | 11.9 | 11.6 | 11.4 | 11.3 | 9.2 | 7.8 | 6.1 | 4.3 | 1.1 | 1.4 |
| e | cat. 3 | 168 | 12.0 | 11.6 | 11.5 | 11.1 | 9.1 | 7.4 | 5.9 | 4.1 | 1.4 | 1.4 |
| f | cat. 4 | 168 | 11.6 | 11.2 | 10.9 | 10.7 | 8.9 | 6.6 | 4.8 | 4.1 | 1.9 | 1.4 |
| g | cat. 5 | 168 | 11.8 | 11.7 | 11.5 | 11.2 | 104 | 7.6 | 6.7 | 5.8 | 1.3 | 1.1 |
| h | Zn | 180 | | | | 8.15 | | 3.8 | | 1.35 | 5.1 | 1.7 |
| | naphthenate | | | | | | | | | | | |

¹⁾μmol of Sn/Zn per kg of polyisocyanate hardener

Demolding Tests:

A casting mold was initially produced by fixing a silicone seal between two glass sheets (float glass, 4 mm) to form a casting cavity having a thickness of 4 mm and an area of about 50 cm².

The isocyanate component A) consisting of 43.7 parts by wt of Desmodur® I and 11 parts by wt of Desmodur® N 3200 was admixed with two parts by wt of Zelec® UN as additive component C) and stirred at room temperature for 16 hours. The respective catalysts (50 mg of Sn based on 1 kg of the total composition, DBTL, catalyst 6: (4,12-dibutyl-2,6,10,14-tetramethyl-1,7,9,15-tetraoxa-4,12-diaza-8-stannaspirol[7.7]pentadecane), catalyst 7: (2,4,6,10,12,14-Hexamethyl-1,7,9,15-tetraoxa-4,12-diaza-8-stannaspirol[7.7]pentadecan)) of the catalyst component D) were dissolved in 43.4 parts by wt of Desmophen® 4011 T as polyol component B) and subsequently mixed at 23° C. with component produced above. The mixture was degassed for 30 minutes at 10 mbar and subsequently introduced into the casting mold. The mixture was cured in a circulating air drying cabinet according to the reported temperature profile and demolded after one day at room temperature.

TABLE 3
Results of performed tests for demolding of the elastomers produced.

| Example | Catalyst | Curing profile | Demolding |
|---|---|---|---|
| 1 (comparative) | none | short | no |
| 2 (comparative) | DBTL | short | no |
| 3 (inventive) | catalyst 6 | short | yes |
| 4 (inventive) | catalyst 7 | short | yes |
| 5 (comparative) | none | long | no |
| 4 (comparative) | DBTL | long | no |
| 5 (inventive) | catalyst 6 | long | yes |
| 6 (inventive) | catalyst 7 | long | yes |

Short curing profile: 4 h at 20° C., linear heating to 60° C. over 0.5 h, 2 h at 60° C., linear heating to 105° C. over 0.5 h, 2 h at 105° C., cooling to room temperature over 1 h.

Long curing profile: 4 h at 20° C., linear heating to 105° C. over 13 h, 2 h at 105° C., cooling to room temperature over 1 h.

Without catalyst or with DBTL as catalyst the polyurethane adhered to the glass so strongly that demolding was not possible and the glass sheets shattered under the stress during demolding. By contrast, the inventive elastomers are very readily demolded irrespective of the chosen temperature profile.

Viscosity Measurements:

The isocyanate component A) from table 4 was admixed with 2 wt %, based on the total mass of isocyanate component A) and polyol component B), of Zelec UN and stirred for one day at room temperature. The respective catalysts (50 mg of Sn based on 1 kg of the total composition, DBTL, catalyst 6: (4,12-Dibutyl-2,6,10,14-tetramethyl-1,7,9,15-tetraoxa-4,12-diaza-8-stannaspirol[7.7]pentadecane)) were dissolved in the relevant amount of Desmophen® 4011 T as polyol component B) and subsequently mixed at 23° C. with the previously produced mixture of the isocyanate component A) and the additive component C). The thus obtained mixtures were transferred into the rheometer and continuously measured at 20° C. and 80° C. (1 datapoint every 15 minutes at 20° C. and I datapoint every minute at 80° C.).

TABLE 4
Results of performed tests for viscosity of the inventive composition at 20° C. and at
80° C.

| | Amount of isocyanate | Amount | Amount | | |
|---|---|---|---|---|---|
| Ex. | component | of Zelec | of polyol | Catalyst | Temperature |
| 7 | 80 g Desmodur ® I | 3.74 g | 74.5 g | none | 20° C. |
| (comparative) | 20 g Desmodur ® | | | | |
| | N3200 | | | | |
| 8 | 80 g Desmodur ® I | 3.74 g | 74.5 g | 0.049 g | 20° C. |
| (comparative) | 20 g Desmodur ® | | | DBTL | |
| | N3200 | | | | |
| 9 | 80 g Desmodur ® I | 3.74 g | 74.5 g | 0.039 g | 20° C. |
| (inv.) | 20 g Desmodur ® | | | cat. 6 | |
| | N3200 | | | | |
| 10 | 80 g Desmodur ® I | 3.74 g | 74.5 g | none | 80° C. |
| (comparative) | 20 g Desmodur ® | | | | |
| | N3200 | | | | |
| 11 | 80 g Desmodur ® I | 3.74 g | 74.5 g | 0.049 g | 80° C. |
| (comparative) | 20 g Desmodur ® | | | DBTL | |
| | N3200 | | | | |
| 12 | 80 g Desmodur ® I | 3.74 g | 74.5 g | 0.039 g | 80° C. |
| (inv.) | 20 g Desmodur ® | | | cat. 6 | |
| | N3200 | | | | |

The viscosity measurements at 20° C. depicted in Graph 1 show that even at this low temperature DBTL results in an accelerated reaction compared to the uncatalyzed reaction since the viscosity of the sample with DBTL undergoes a stronger increase than the viscosity of the sample without catalyst.

Use of the inventive catalyst 6 results in a slower increase in viscosity compared to the uncatalyzed system at 20° C. This means that the inventive composition exhibits an extended potlife even compared to the uncatalyzed system. This is particularly advantageous since this extends the processing time of the inventive composition.

Not only the extended potlife at 20° C. but also the increased catalytic activity of the inventive catalyst at 80° C. compared to the uncatalyzed system as is evident from Graph 2 is a further advantage of the inventive composition.

Production of an Eyeglasses Lens Blank

The casting mold was initially assembled by clipping together two glass shell molds (diameter 85 mm, internal radius 88 mm, Shamir Insight, Inc.) with a plastic sealing ring so as to form a molding cavity.

The casting system consisted of a mixture 1: 80 g of Desmodur® I, 20 g of Desmodw N 3200 and 3.76 g of Zelec® UN which was mixed and left to stand overnight.

Mixture 2 were mixed together from 73,9 g of Desmophen® 4011 T and 0.04 g of catalyst 6: (4,12-dibutyl-2,6,10,14-tetramethyl-1,7,9,15-tetraoxa-4,12-diaza-8-stannaspirol[7.7]pentadecane) and likewise left to stand overnight

Thereafter, mixture 1 was transferred into a flask and evacuated at 10 mbar for 30 minutes. Mixture 2 was then added to the flask and the final mixture 3 was stirred and degassed at 10 mbar for 30 minutes. Mixture 3 was then filtered through a 5 μm filter and filled into a syringe and the casting mold was then completely filled.

The filled casting mold was dried in a drying cabinet with the following temperature profile: 4 hours at 20° C.; linearly heated to 100° C. over 13 hours; heat treated at 100° C. for 2 hours; heat treated at 120° C. for 2 hours. The casting mold was finally cooled to room temperature and after complete cooling first the collar and then the two glass bodies were manually removed.

In this way a completely clear, transparent and streak-free eyeglasses lens blank was obtained. Transmission was 93% for standard light type D65. Refractive index e was 1.50 at 23° C.

1.-17. (canceled)

18. A composition comprising an
isocyanate component A) comprising at least one cycloaliphatic or araliphatic diisocyanate, a polyol component B) comprising at least one polyol having an OH number of 80 to 1000 mg KOH/g, an
additive component C) comprising at least one internal demolding agent, wherein the demolding agent is at least one mono- and/or dialkyl phosphate having 8 to 12 carbon atoms in the alkyl radical, and a
catalyst component D) comprising at least one inorganic metal complex compound as a thermolatent catalyst,
wherein the thermolatent catalyst exhibits a quotient of the reaction rates between catalyzed reaction and uncatalyzed reaction of ≦5.0 at 30° C. and of ≧1.1 at 60° C.

19. The composition as claimed in claim 18, wherein the inorganic metal complex compound comprises bismuth, titanium, zinc, zirconium or tin, preferably bismuth or tin and particularly preferably tin as the central atom.

20. The composition as claimed in claim 18, wherein the inorganic metal complex compound comprises at least one ligand which comprises at least one ether, thioether or amino group and/or is a chelate ligand, preferably comprises at least one amino group and/or is a chelate ligand and particularly preferably comprises at least one amino group and is a chelate ligand.

21. The composition as claimed in claim 18, wherein the inorganic metal complex compound is selected from the group of formulae I, II or III: 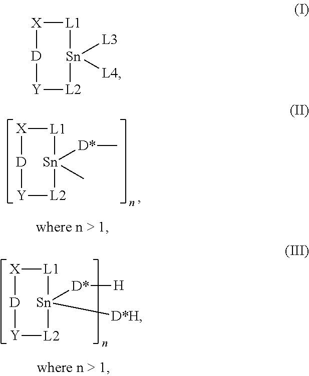
wherein:
D represents —O—, —S— or —N(R1)—, wherein R1 represents a saturated or unsaturated, linear or branched, aliphatic or cycloaliphatic radical or an optionally substituted aromatic or aliphatic radical having up to 20 carbon atoms which may optionally comprise heteroatoms from the group of oxygen, sulfur, nitrogen or represents hydrogen or the radical 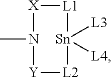
or R1 and L3 together represent —Z-L5-;
D* represents —O— or —S—;
X, Y and Z represent identical or different radicals selected from alkylene radicals having the formulae —C(R2)(R3)—, —C(R2)(R3)—C(R4)(R5)— or —C(R2)(R3)—C(R4)(R5)—C(R6)(R7)— or ortho-arylene radicals having the formulae 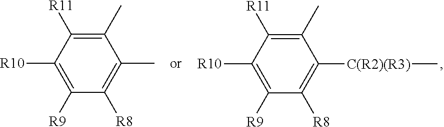
wherein R2 to R11 independently of one another represent saturated or unsaturated, linear or branched, aliphatic or cycloaliphatic or optionally substituted aromatic or aliphatic radicals having up to 20 carbon atoms which may optionally comprise heteroatoms from the group of oxygen, sulfur, nitrogen or represent hydrogen;
L1, L2 and L5 independently of one another represent —O—, —S—, —OC(═O)—, —OC(═S)—, —SC(═O)—, —SC(═S)—, —OS(═O)₂O—, —OS(═O)₂— or —N(R12)—,
wherein R12 represents a saturated or unsaturated, linear or branched, aliphatic or cycloaliphatic radical or an optionally substituted aromatic or aliphatic radical having up to 20 carbon atoms which may optionally comprise heteroatoms from the group of oxygen, sulfur, nitrogen or represents hydrogen;
L3 and L4 independently of one another represent —OH, —SH, —OR13, -Hal, —OC(═O)R14, —SR15, —OC(═S)R16, —OS(═O)₂OR17, —OS(═O)₂R18 or —NR19R20 or L3 and L4 together represent -L1-X-D-Y-L2-,
wherein R13 to R20 independently of one another represent saturated or unsaturated, linear or branched, aliphatic or cycloaliphatic or optionally substituted aromatic or aliphatic radicals having up to 20 carbon atoms which may optionally comprise heteroatoms from the group of oxygen, sulfur, nitrogen or represent hydrogen.

22. The composition as claimed in claim 18, wherein the internal demolding agent comprises at least one compound having a pK_{A} of ≦4.60.

23. The composition as claimed in claim 18, wherein the isocyanate component A) comprises a mixture of a) at least one cycloaliphatic or aliphatic diisocyanate and b) at least one acyclic, aliphatic di- or triisocyanate or one oligomer of an aliphatic diisocyanate.

24. The composition as claimed in claim 23, wherein the mixture in the isocyanate component A) is present in a weight ratio of a) to b) between 55:45 and 94:6.

25. The composition as claimed in claim 23, wherein the oligomer of an aliphatic diisocyanate comprises at least one allophanate, one biuret, one uretdione, one isocyanurate and/or one urethane group.

26. The composition as claimed in claim 25, wherein the aliphatic diisocyanate is a linear aliphatic diisocyanate.

27. The composition as claimed in claim 18, wherein the isocyanate component A) comprises at least 3,5,5-trimethyl-1-isocyanato-3-isocyanatomethylcyclohexane, 4,4′-methylenebis(cyclohexyl isocyanate), 1,3-bis(isocyanatomethyl)benzene, 1,4-bis(isocyanatomethyl)benzene, 2,5-bis(isocyanatomethyl)bicyclo[2.2.1]heptane, 2,6-bis(isocyanatomethyl)bicyclo[2.2.1]heptane, 1,3-diisocyanato-2-methylcyclohexane and/or 1,3-diisocyanato-6-methylcyclohexane.

28. The composition as claimed in claim 18, wherein the polyol component B) comprises at least one polyether polyol or one polyester polyol, or mixtures of a trimethylolpropane-initiated polyether polyol with at least one further polyether polyol.

29. The composition as claimed in claim 18, wherein the isocyanate groups of the isocyanate component A) and the hydroxyl groups of the polyol component B) are in a ratio of 1.50:1.00 to 1.00:1.50.

30. A process for producing an elastomer where a composition according to claim 18 is cured, optionally with heating.

31. An elastomer obtained by the process as claimed in claim 30.

32. A method comprising utilizing the composition as claimed in claim 18 for producing transparent molded articles.

33. The method of claim 32, wherein the transparent molded article is an optical lens or a part of an optical lens, wherein the optical lens may be a converging lens, a diverging lens, a glazing, a headlight or an eyeglasses lens.

34. A transparent molded article comprising a composition as claimed in claim 18.
